(19) United States
(12) Patent Application Publication
(10) Pub. No.: US 2010/0086000 A1
(43) Pub. Date: Apr. 8, 2010

(54) Laser Discharge Tube Assembly for a Gas Laser and Production Method for the Same

(75) Inventor: Thomas Zeller, Sindelfingen (DE)

Correspondence Address: FISH & RICHARDSON PC, P.O. BOX 1022, MINNEAPOLIS, MN, 55440-1022, US

(73) Assignee: TRUMPF LASER- UND SYSTEMTECHNIK GMBH, Ditzingen (DE)

(21) Appl. No.: 12/581,263

(22) Filed: Oct. 19, 2009

Related U.S. Application Data
(63) Continuation of application No. PCT/DE2008/000717, filed on Apr. 28, 2008.

(30) Foreign Application Priority Data
Apr. 27, 2007 (DE) 102007020427.4

(51) Int. Cl. H01S 3/03; B05D 5/12

(52) U.S. Cl. 372/61; 427/64

(57) ABSTRACT

A laser discharge tube assembly for a HF-excited gas laser includes at least two electrodes that are disposed outside of the laser discharge tube, the electrodes are disposed at a separation from the laser discharge tube and are completely embedded in at least one insulating dielectric material.

### CROSS REFERENCE TO RELATED APPLICATION

This application is a continuation of and claims priority under 35 U.S.C. §120 to PCT/DE2008/000717, filed on Apr. 28, 2008, and designating the U.S., which claims priority to German Patent Application No. DE 10 2007 020 427.4, filed on Apr. 27, 2007. The contents of both the prior applications are hereby incorporated by reference in their entirety.

### TECHNICAL FIELD

The present disclosure relates to a laser discharge tube for a high frequency (HF)-excited gas laser with at least two electrodes that are disposed outside of the laser discharge tube, and a production method therefore.

### BACKGROUND

Electric gas discharge with a HF (high frequency) alternating field (HF excitation) can be used for exciting CO₂ gas lasers (e.g., instead of direct current excitation (DC excitation)). Different electrode configurations can be used to provide the HF alternating field to gas in a laser discharge tube. For example, metallic electrodes that are in direct contact with the laser gas are often used for diffusion-cooled CO₂ gas lasers. Dielectric electrodes are often used for flowed CO₂ gas lasers. “Dielectric electrodes” define an arrangement, in which a dielectric is disposed between the (metallic) electrodes and the laser gas. Thus, the electrodes are not in contact with the laser gas and are located outside of the laser discharge tube. Energy is coupled into the gas capacitively via the dielectric material of the dielectric electrode.

The dielectric between the electrodes and the laser gas can substantially contribute to the stabilization of discharge at high power densities, since the voltage drop at the dielectric counteracts local current increases in the gas discharge. The dielectric has the function of a distributed capacitive ballast resistor, the effect of which is generally determined by the thickness, the excitation frequency and the relative dielectric constant. Air, for example, has a relative dielectric constant of almost 1 and can be optimally suited as a dielectric for stabilizing the discharge. This increased discharge stability, however, can be accompanied by an increased overall voltage at the electrodes, thereby increasing the requirements concerning the proof voltage of the discharge arrangement. Typically, the voltage rises the larger the thickness of the dielectric and the smaller the excitation frequency and relative dielectric constant.

Tube generators with frequencies of, e.g., 13.56 MHz or 27.12 MHz are often used for HF excitation of CO₂ gas lasers. Generally, the physical advantages of HF excitation can be offset by the cost: For example, tube generators can be expensive and have an efficiency of merely 60-70%. HF excitation with switching power supplies that are composed of semiconductor devices and are operated at excitation frequencies of 1-4 MHz, e.g., 3.39 MHz can be less expensive. The low excitation frequencies that are associated with the use of switching power supplies, however, can increase the risk of flashovers and/or disruptive breakdowns due to voltage increases at the electrodes.

A flashover is the occurrence of an electrical discharge in a gaseous, liquid or solid non-conducting medium caused by the occurrence of an excessive field strength between two electrical conductors.

An electrical breakdown occurs when an electrical voltage that is higher than the dielectric strength is applied to an insulator. Current flows through the insulator which is accompanied by ionization of the insulator and formation of plasma. The resulting ultraviolet radiation knocks out further electrons from the insulator, which are then free to carry current. Ionization turns the insulator into an electrical conductor and the insulator can be permanently or irreversibly destroyed. Disruptive breakdowns can concern solid, liquid or gaseous insulators.

In HF excited gas lasers, flashovers can occur from electrode to electrode along the laser discharge tube, or from the electrodes to the housing, e.g., the corner housings or suction-extraction housings of a squarely folded laser resonator.

Since the coupled-in power and the geometry of the laser resonator remain unchanged when switching power supplies are used instead of tube generators, measures should be taken to reduce the risk of flashovers and/or disruptive breakdowns. One conventional measure to prevent flashovers or disruptive breakdowns or to reduce the risk of flashovers and disruptive breakdowns is to coat the electrodes with a dielectrically strong material. Electrode arrangements of this type for a gas laser are disclosed, e.g., in U.S. Pat. No. 5,172,389, JP 01-066983 or EP-A-0 550 759.

The risk of disruptive breakdowns and flashovers can be assessed by means of the dielectric strength E0. The dielectric strength E0 of an insulator is the maximum electric field strength that a material can tolerate without causing a disruptive breakdown. Disruptive breakdowns are generally prevented as long as the electric field strength E is smaller than the dielectric strength E0. Solids generally have a greater dielectric strength than gases, since a solid material has a higher density and impact ionization only starts at much higher field strengths in solids. The acceleration time of electrons in a solid is too short to obtain the appropriate energy prior to hitting an atom. In general, the higher the dielectric strength E0 of an insulator, the smaller is the risk of disruptive breakdowns and/or flashovers. Air has a dielectric strength of 2-3 kV/mm, quartz glass (SiO₂) of 15-20 kV/mm and aluminum oxide (Al₂O₃) of 10-17 kV/mm (depending on the Al₂O₃ content). The values stated above represent guidelines since the dielectric strength depends on further parameters, such as the exact composition and purity of the materials and the voltage exposure time. Moreover, the dielectric strength of many materials is not proportional to the thickness.

### SUMMARY

The present disclosure relates to a laser discharge tube assembly for a high frequency (HF)-excited gas laser with at least two electrodes that are disposed outside of the laser discharge tube, and a production method therefore. The laser discharge tube assembly can further reduce the risk of flashovers and/or disruptive breakdowns in a laser discharge tube of the above-mentioned type.

In certain embodiments, reduced risk is achieved by disposing the electrodes at a separation from the laser discharge tube and are completely embedded (as used herein, “completely embedded” means entirely embedded except for their electrical connections) into at least one insulating dielectric material. The electrodes are not directly applied to the laser discharge tube but are completely embedded into a further dielectric, thereby reducing the risk of flashovers and/or disruptive breakdowns.

Ceramic materials, such as, e.g., aluminium oxide (Al₂O₃) and aluminium nitride (AlN), or high-melting plastic materials, such as, e.g., PTFE (polytetrafluoroethylene), polyetheretherketone (PEEK), PFA (perfluoroalkoxy copolymer) and E-CTFE (ethylene chlorotrifluoroethylene), can be used as insulating dielectric materials. According to the Ceramic Industry Association, the dielectric strength of some ceramic materials is as follows:

| | | |
|---|---|---|
| Aluminium oxide (80-86% Al2O3) | 10 | kV/mm |
| Aluminium oxide (86-95% Al2O3) | 15 | kV/mm |
| Aluminium oxide (95-99% Al2O3) | 15 | kV/mm |
| Aluminium oxide (>99% Al2O3) | 17 | kV/mm |
| Aluminium nitride | >20 | kV/mm |

PTFE (polytetrafluoroethylene) is known, e.g., by the trade names Teflon (DuPont), Hostaflon (Hoechst, Dyneon) and Algoflon (Solvay Solexis), PEEK (polyetheretherketone) is known by the trade names Tecapeek (Ensinger) and VICTREX PEEK (Victrex), PFA (perfluoroalkoxy copolymer) is known by the trade names Hyflon (Solvay Solexis), Tecaflon PFA (Ensinger), Teflon-PFA (DuPont) and Hostaflon-PFA (Hoechst), and E-CTFE (ethylene chlorotrifluoroethylene) is known by the trade names Halar (Solvay Solexis) and Tecaflon ECTFE (Ensinger). According to the manufacturers, the dielectric strength of some plastic materials is as follows:

| | | |
|---|---|---|
| PEEK | 19 | kV/mm |
| Teflon (DuPont) | 36 | kV/mm |
| Hyflon (Solvay Solexis) | 35-40 | kV/mm |
| Halar (Solvay Solexis) | 30-35 | kV/mm |
| Tecaflon ECTFE (Ensinger) | 40 | kV/mm |

In some embodiments, the ceramic material is fired in the area that surrounds the electrodes on the inner side, since the dielectric strength of fired ceramic material is up to 10 times higher than that of sprayed ceramic material. Moreover, in case of sprayed ceramic materials, air can get trapped in the ceramic material. These air inclusions can become conducting and the electric field strength increases accordingly.

In general, in one aspect, the invention features a laser discharge tube assembly for a HF-excited gas laser, the laser discharge tube assembly including a laser discharge tube and at least two electrodes disposed outside of the laser discharge tube, wherein the electrodes are disposed at a separation from the laser discharge tube and are completely embedded into at least one insulating dielectric material.

Embodiments of the laser discharge tube assembly can include one or more of the following features and/or features of other aspects. For example, the at least one insulating dielectric material can be a ceramic material or a plastic material. The ceramic material can be fired in the area that surrounds the electrodes on the inner side.

The insulating dielectric material can include an outer tube disposed on the laser discharge tube and the electrodes are completely embedded into the outer tube. The outer tube can be pushed onto the laser discharge tube or can be disposed at a separation from the laser discharge tube. The outer tube can be formed by an inner support tube and an outer dielectric. The outer dielectric can be a sprayed ceramic material. The inner support tube and the outer dielectric can be composed of the same insulating dielectric material. The insulating dielectric material can be a plastic material or a fired and a sprayed ceramic material. The inner support tube and the outer dielectric can be composed of different insulating dielectric materials. The inner support tube can be a ceramic support tube and the outer dielectric is a plastic material.

One or more outer strip of at least one insulating dielectric material can be disposed on the laser discharge tube and the electrodes are completely embedded into the outer strips. The one or more outer strip can be disposed to be in contact with the laser discharge tube or can be disposed at a separation from the laser discharge tube.

The electrodes can be disposed in a helical shape around the laser discharge tube.

In another aspect, the invention features a HF-excited gas laser that includes at least one laser discharge tube assembly of the foregoing aspect, wherein an annular gap is provided between the laser discharge tube and the outer tube. The gap can have a circular shape and can be filled with air during operation of the gas laser.

In general, in another aspect, the invention features a method for producing an outer tube of a laser discharge tube assembly of a HF-excited gas laser, the method including applying electrodes onto a support tube of an insulating dielectric material and applying an outer dielectric of the insulating dielectric material onto the electrodes, wherein the electrodes are completely embedded into the insulating dielectric material.

Implementations of the method can include one of more of the following features and/or features of other aspects. For example, the electrodes can be applied by spraying the conducting metallic layers onto the support tube. The outer dielectric can be applied by spraying the insulating dielectric material onto the electrodes. The insulating dielectric material can also be sprayed onto the support tube.

In some embodiments, the insulating dielectric material is a ceramic material.

The support tube can be produced by spraying the insulating dielectric material.

A fired ceramic tube can be used as the support tube.

Applying the electrodes can include covering the support tube with a template having recesses, applying a conducting material to the support tube via the recesses, and removing the template after applying the conducting material to provide the electrodes. The conducting material can be a metal, e.g., copper.

The method can include impregnating the outer dielectric of insulating material applied to the electrodes to protect the outer dielectric against moisture.

In general, in a further aspect, the invention features a method for producing a laser discharge tube assembly of a HF-excited gas laser, the method including immersing a strip-shaped electrode into a liquid insulating dielectric material, drying the insulating dielectric material on the electrode, wherein the dried insulating dielectric material forms an outer strip completely embedding the electrode, and disposing the embedded electrode at a separation from a laser discharge tube to provide the laser discharge tube assembly. Implementations of the method can include one of more features of other aspects.

In general, in another aspect, the invention features a method for producing a laser discharge tube assembly of a HF-excited gas laser, the method including coating a strip-shaped electrode in a wet method or by powder coating with an insulating dielectric material, burning-in or sintering the insulating dielectric material, wherein after coating and burning-in or sintering the electrode is completely embedded in the insulating dielectric material, and disposing the embedded electrode at a separation from a laser discharge tube to provide the laser discharge tube assembly. Implementations of the method can include one of more features of other aspects.

In general, in another aspect, the invention features an outer tube of at least one insulating dielectric material is disposed on the laser discharge tube, wherein the electrodes are completely embedded into the insulating dielectric material. The outer tube can be pushed onto the laser discharge tube. The separate design of the laser discharge tube and the outer tube can be advantageous in that the laser discharge tubes can be separately exchanged. The interaction between the HF energy and the material of the laser discharge tubes (e.g., quartz glass) can cause defects in the material, which impair the laser beam quality. When the electrodes are directly applied to the laser discharge tube, the laser discharge tubes typically cannot be separately exchanged but only together with the electrodes, which typically increases the cost of replacement parts for a laser. The outer tube can be formed from an inner support tube and an outer dielectric. The support tube and the outer dielectric can be made from the same insulating dielectric material or from different insulating dielectric materials.

In some embodiments, one or more outer strips of at least one insulating dielectric material are mounted to the laser discharge tube, where the electrodes are completely embedded into the outer strips.

In certain aspects, the disclosure relates to a method for producing the outer tube designed as described above. The method can include the following method steps:

applying, in particular, spraying the electrodes as conducting, in particular, metallic layers, onto a support tube of insulating dielectric material, in particular, ceramic material; and

applying, in particular, spraying an outer dielectric of insulating dielectric material, in particular, ceramic material onto the electrodes and preferably also onto the support tube such that the electrodes (except for their electric connections) are completely surrounded by insulating dielectric material.

The entire outer tube, i.e., also the support tube, can be produced in layers by spraying (e.g., plasma and flame spraying) an insulating dielectric material, in particular, ceramic material. A ceramic material may, e.g., be sprayed onto a water-cooled, rotating mandrel using a plasma burner until a support tube having a wall thickness of approximately 2 mm is obtained. The use of a conical mandrel also greatly facilitates the production of a conical tube. In another advantageous variant, a support tube of a fired ceramic material, e.g., Al₂O₃ (aluminium oxide) is used.

The electrodes can be disposed onto the support tube by covering the support tube with a template having recesses, then a metal layer having a thickness of, e.g., 0.2 to 0.5 mm (e.g. copper, aluminium or molybdenum) is applied to the support tube via the recesses, and subsequently the template is removed.

When the outer dielectric of insulating dielectric material has been applied to the electrodes, the insulating dielectric material may be organically or inorganically impregnated as a protection against moisture.

In a further aspect, the invention features a method for producing the outer strip of the above-described design with the following method steps:

immersion of a strip-shaped electrode into liquid insulating dielectric material; and

allowing the insulating dielectric material to dry on the electrode.

Implementations of the method may include one or more of the features discussed above with respect to other aspects. In another aspect, the invention features a method for producing the outer strip designed as described above with the following method steps:

coating a strip-shaped electrode in a wet method or by powder coating with an insulating dielectric material, in particular plastic material, and

burning-in or sintering the insulating dielectric material at temperatures of approximately 200 to 500° C.

Implementations of the method may include one or more of the features discussed above with respect to other aspects.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows an embodiment a CO₂ gas laser with a folded laser resonator;

FIG. 2a shows a laser discharge tube assembly with straight electrodes;

FIG. 2b shows a laser discharge tube assembly with helical electrodes;

FIGS. 3a-3c show the individual method steps for producing a first embodiment of the inventive laser discharge tube assembly with two electrodes that are embedded into a dielectric tube;

FIG. 4 shows a cross-sectional view of an embodiment of a dielectric tube; and

FIG. 5 shows a cross-sectional view of an embodiment of a laser discharge tube assembly with two electrodes, each being embedded into one ceramic outer strip, wherein the outer strips are disposed at a separation from the laser discharge tube (FIG. 5a) or directly on the laser discharge tube (FIG. 5b).

### DETAILED DESCRIPTION

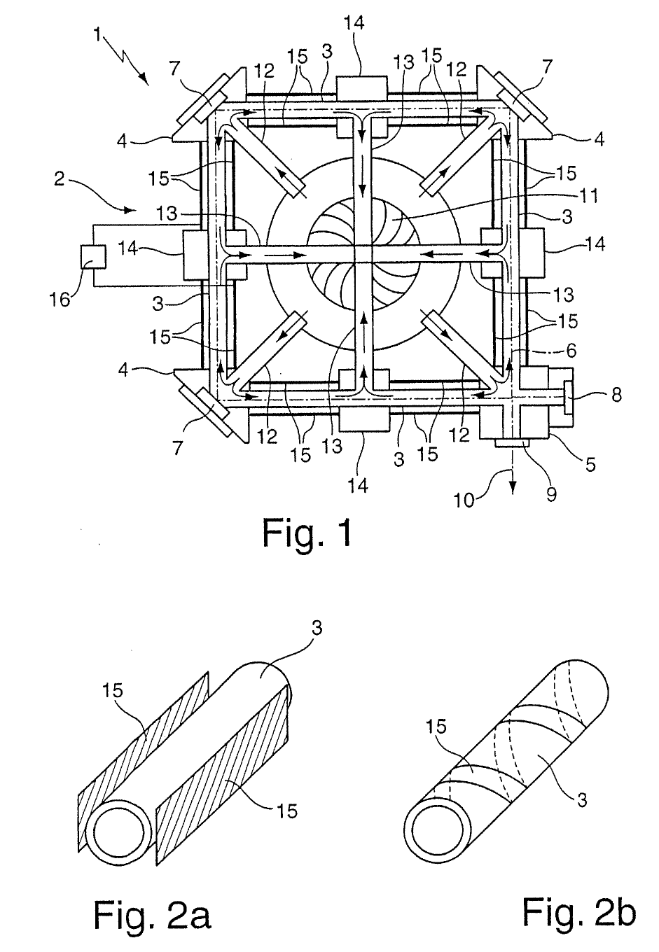

Referring to FIG. 1, a CO₂ gas laser 1 includes a squarely folded laser resonator 2 with four joined laser discharge tubes 3 which are connected to each other via corner housings 4, 5. A laser beam 6 that extends in the direction of the axes of the laser discharge tubes 3 is shown with dash-dotted lines. Deflection mirrors 7 in the corner housings 4 are used to deflect laser beam 6 through 90° in each case. A rear mirror 8 and a partially transmissive decoupling mirror 9 are disposed in corner housing 5. Rear mirror 8 is highly reflecting and reflects laser beam 6 through 180° such that laser discharge tubes 3 are passed again in the opposite direction. Part of laser beam 6 is decoupled from laser resonator 2 at partially transmissive decoupling mirror 9, the other part remains in laser resonator 2 and passes again through laser discharge tubes 3. The laser beam that is decoupled from laser resonator 2 via decoupling mirror 9 is designated by 10. A radial fan 11 acting as a pressure source for laser gas and being connected to corner housings 4, 5 via laser gas supply lines 12 is disposed in the center of folded laser resonator 2. Suction lines 13 extend between suction-extraction housings 14 and radial fan 11. The flow direction of the laser gas inside laser discharge tubes 3 and in supply and suction lines 12, 13 is illustrated by arrows. The laser gas is excited via electrodes 15 that are disposed adjacent to laser discharge tubes 3 and are connected to a HF generator 16. A tube generator having an excitation frequency of 13.56 MHz or 27.12 MHz is typically used as HF generator 16.

Switching power supplies made from semiconductor devices having an excitation frequency of between 1 and 4 MHz may alternatively be used. When switching power supplies are used, the excitation frequencies are typically lower, which can increase the danger of flashovers and/or disruptive breakdowns, since the voltage rises.

The separation between the ends of electrodes 15 and the flanges of supply and suction lines 12, 13 should be sufficiently large since electrodes 15 and the neighboring flanges of supply lines 12 in corner housings 4, 5 or suction lines 13 in suction-extraction housings 14 have different electric potentials.

Referring to FIG. 2a, electrodes 15 are disposed in a straight line along laser discharge tubes 3, i.e., parallel to the respective tube axis. For gas lasers having a greater power, it can be advantageous to dispose the electrodes 15 in a helical shape around the laser discharge tubes 3 (as shown in FIG. 2b).

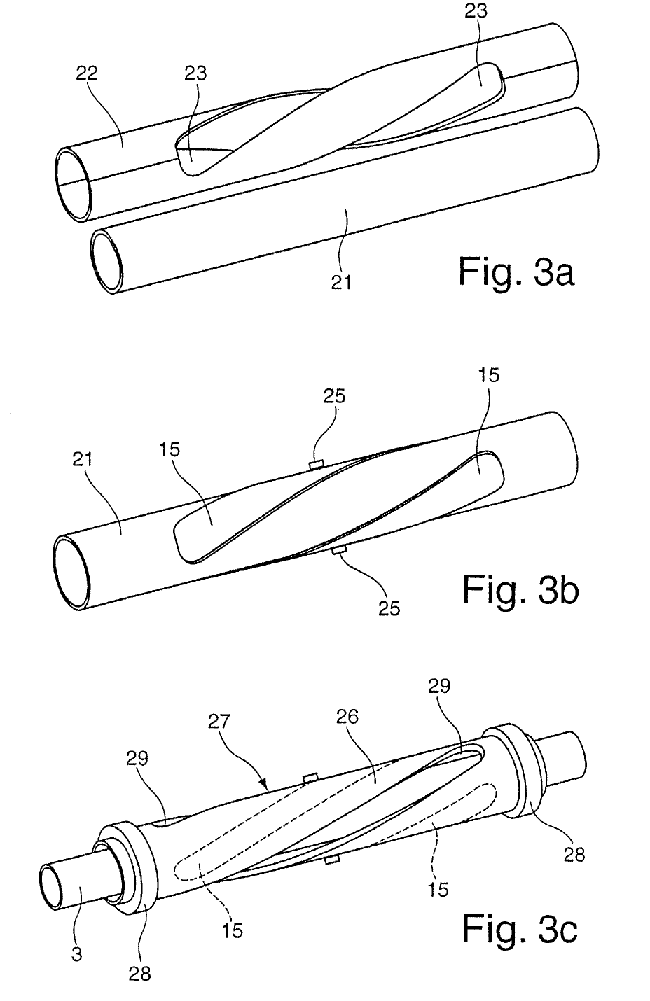

The production of the electrode arrangement is described below with reference to FIG. 3 taking helical electrodes 15 as an example:

In a first method step, an inner support tube 21 of an insulating dielectric material is produced. Towards this end, a ceramic material, e.g., aluminium oxide (Al₂O₃), is sprayed onto a water-cooled rotating mandrel (not shown) using a plasma burner until a support tube 21 having a wall thickness of approximately 2 mm is obtained. Aluminium oxide (Al₂O₃) of high purity is used as ceramic material, since the dielectric strength of support tube 21 depends on the purity of the aluminium oxide. For aluminium oxides having a purity >99%, i.e., an Al₂O₃ content >99% (e.g., type C799), the dielectric strength is 17 kV/mm according to the association of technical ceramic materials. For aluminium oxides having an Al₂O₃ content of 80% to 86% (e.g., type C780), the dielectric strength is 10 kV/mm and for aluminium oxides having an Al₂O₃ content of 86% to 95% (e.g., type C786) and an Al₂O₃ content of 95 to 99% (e.g., type C795), the dielectric strength is 15 kV/mm in each case. It should be noted that the dielectric strength can depend on further parameters such as the voltage exposure time. The dielectric strength of many materials is moreover not necessarily proportional to the thickness.

In order to further increase the dielectric strength of support tube 21, support tube 21 can be produced by extrusion. Extrusion methods are used, for example, for producing rotationally symmetrical components having very large length/cross-section ratios, e.g., tubes. During extrusion, various organic binding agents and lubricants can be added to the powder in addition to water to produce a plastically deformable compound. The extruded tube is subsequently sintered at high temperatures. The binding agent thereby escapes and a compact ceramic material without pores is obtained. This can substantially increase the dielectric strength compared to sprayed porous ceramic material.

The electrodes are generated in a second method step. Towards this end, support tube 21 is covered by a divided template 22 having two helical recesses 23 disposed at an angle of 180° opposite to each other (see, FIG. 3a). Metal (e.g., copper) is subsequently sprayed via the plasma burner such that after removing template 22, two helical metal strips having a thickness of approximately 0.2 to 0.5 mm remain on the support tube 21 as electrodes 15 (see, FIG. 3b). Each metal strip is soldered at the center to one connecting contact 25 that is used for later contacting of the electrodes 15. The electrodes 15 may also be applied to support tube 21 through brushing. When straight electrodes are used, template 22 has two straight recesses disposed at 180° opposite to each other instead of helical recesses 23.

In a third method step, a further layer of insulating dielectric material having a thickness of approximately 2 mm is sprayed as the outer dielectric 26 onto support tube 21 such that electrodes 15 are completely enclosed or embedded in a dielectric outer tube 27 (see, FIG. 3c). In other words, electrodes 15 are surrounded on all sides by insulating dielectric materials. Ceramic materials or plastic materials, such as, e.g. PTFE, PFA and C-CTFE, may be used as materials for outer dielectric 26. Dielectric outer tube 27 with embedded electrodes 15 is pushed onto laser discharge tube 3 and fixed by means of retaining rings 28 (e.g., formed of Teflon). Viewing windows 29 are cut into outer tube 27 in order to improve observation of the discharge in laser discharge tube 3. Outer tube 27 is finally inorganically impregnated as protection against moisture.

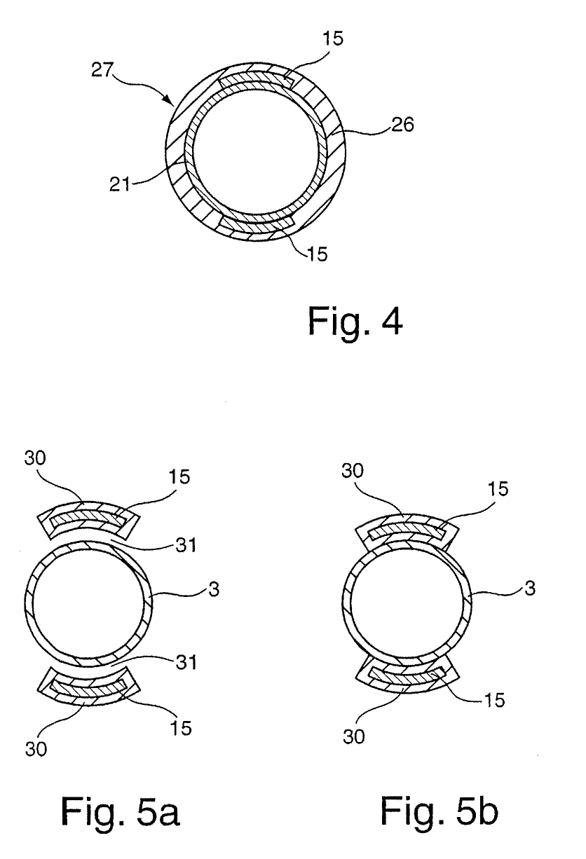

Referring to FIG. 4, an electrode arrangement includes an dielectric outer tube 27 with embedded electrodes 15. Electrodes 15 are disposed on an inner support tube 21. Electrodes 15 and support tube 21 are surrounded on the outer side by an outer dielectric 26. Outer tube 27 with embedded electrodes 15 can be pushed onto laser discharge tube 3 or be disposed at a separation from laser discharge tube 3 such that an air gap is generated between laser discharge tube 3 and outer tube 27.

FIG. 5a shows a laser discharge tube assembly that includes laser discharge tube 3 and two straight electrodes 15 on its outside, which are disposed opposite to each other at a separation from laser discharge tube 3 and are completely embedded in an outer strip 30 of insulating dielectric material. Outer strip 30 with embedded electrodes 15 is disposed at a separation from laser discharge tube 3 such that an air gap 31 is produced between laser discharge tube 3 and outer strip 30. Air gap 31 represents a further dielectric and can stabilize the discharge in laser discharge tubes 3. Alternatively, referring to FIG. 5b, outer strip 30 can be directly applied to laser discharge tube 3.

Outer strips 30 with embedded electrodes 15 can be produced, e.g., by coating strip-shaped electrodes in a wet method or by powder coating with an insulating dielectric material such as Teflon, Halar, etc. and subsequent firing, sintering or air drying of the insulated dielectric material on electrodes 15. Outer strips 30 having layer thicknesses of more than 20 μm may also be applied to the strip-shaped electrodes 15 by thermal spraying. In this case, mainly plasma spraying has turned out to be favourable. During plasma spraying, oxide ceramic powders such as, e.g., aluminum oxide, or powder mixtures such as, e.g., aluminum oxide/titanium dioxide, are applied in a plasma flame having a temperature of approximately 10,000° C.

In some embodiments, electrodes 15 are formed as metal strips that are embedded into outer tube 27 or outer strip 30. Electrodes 15 may also be realized in the form of a conducting layer, e.g., of graphite. The conducting layer may be sprayed or brushed onto inner support tube 21. Electrodes of graphite may, e.g., be produced from a graphite tube by laser cutting or milling.

A number of embodiments of the invention have been described. Nevertheless, it will be understood that various modifications may be made without departing from the spirit and scope of the invention. Accordingly, other embodiments are within the scope of the following claims.

What is claimed is:

1. A laser discharge tube assembly for a HF-excited gas laser, the laser discharge tube assembly comprising:
a laser discharge tube;
at least two electrodes disposed outside of the laser discharge tube,
wherein the electrodes are disposed at a separation from the laser discharge tube and are completely embedded into at least one insulating dielectric material.

2. The laser discharge tube assembly of claim 1, wherein the at least one insulating dielectric material is a ceramic material or a plastic material.

3. The laser discharge tube assembly of claim 2, wherein the ceramic material is fired in the area that surrounds the electrodes on the inner side.

4. The laser discharge tube assembly of claim 1, wherein the insulating dielectric material comprises an outer tube disposed on the laser discharge tube and the electrodes are completely embedded into the outer tube.

5. The laser discharge tube assembly of claim 4, wherein the outer tube is pushed onto the laser discharge tube or is disposed at a separation from the laser discharge tube.

6. The laser discharge tube assembly of claim 4, wherein the outer tube is formed by an inner support tube and an outer dielectric.

7. The laser discharge assembly of claim 6, wherein the outer dielectric is a sprayed ceramic material.

8. The laser discharge tube assembly of claim 6, wherein the inner support tube and the outer dielectric are composed of the same insulating dielectric material.

9. The laser discharge tube assembly of claim 8, wherein the insulating dielectric material is a plastic material or a fired and a sprayed ceramic material.

10. The laser discharge tube assembly of claim 6, wherein the inner support tube and the outer dielectric are composed of different insulating dielectric materials.

11. The laser discharge tube assembly of claim 10, wherein the inner support tube is a ceramic support tube and the outer dielectric is a plastic material.

12. The laser discharge tube assembly of claim 1, wherein one or more outer strip of at least one insulating dielectric material is disposed on the laser discharge tube and the electrodes are completely embedded into the outer strips.

13. The laser discharge tube assembly of claim 12, wherein the one or more outer strip is disposed to be in contact with the laser discharge tube or is disposed at a separation from the laser discharge tube.

14. The laser discharge tube assembly of claim 1, wherein the electrodes are disposed in a helical shape around the laser discharge tube.

15. A HF-excited gas laser, comprising:
at least one laser discharge tube assembly according to claim 1,
wherein an annular gap is provided between the laser discharge tube and the outer tube.

16. The HF-excited gas laser of claim 15, wherein the gap has a circular shape and is filled with air during operation of the gas laser.

17. A method for producing an outer tube of a laser discharge tube assembly of a HF-excited gas laser, comprising:
applying electrodes onto a support tube of an insulating dielectric material; and
applying an outer dielectric of the insulating dielectric material onto the electrodes,
wherein the electrodes are completely embedded into the insulating dielectric material.

18. The method of claim 17, wherein the electrodes are applied by spraying the conducting metallic layers onto the support tube.

19. The method of claim 17, wherein the outer dielectric is applied by spraying the insulating dielectric material onto the electrodes.

20. The method of claim 19, wherein the insulating dielectric material is also sprayed onto the support tube.

21. The method of claim 17, wherein the insulating dielectric material is a ceramic material.

22. The method of claim 17, wherein the support tube is produced by spraying the insulating dielectric material.

23. The method of claim 17, wherein a fired ceramic tube is used as the support tube.

24. The method of claim 17, wherein applying the electrodes comprises covering the support tube with a template having recesses;
applying a conducting material to the support tube via the recesses; and
removing the template after applying the conducting material to provide the electrodes.

25. The method of claim 24, wherein the conducting material is a metal.

26. The method of claim 25, wherein the metal is copper.

27. The method of claim 17, further comprising impregnating the outer dielectric of insulating material applied to the electrodes to protect the outer dielectric against moisture.

28. A method for producing a laser discharge tube assembly of a HF-excited gas laser, comprising:
immersing a strip-shaped electrode into a liquid insulating dielectric material;
drying the insulating dielectric material on the electrode, wherein the dried insulating dielectric material forms an outer strip completely embedding the electrode; and
disposing the embedded electrode at a separation from a laser discharge tube to provide the laser discharge tube assembly.

29. A method for producing a laser discharge tube assembly of a HF-excited gas laser, comprising:
coating a strip-shaped electrode in a wet method or by powder coating with an insulating dielectric material;
burning-in or sintering the insulating dielectric material, wherein after coating and burning-in or sintering the electrode is completely embedded in the insulating dielectric material; and
disposing the embedded electrode at a separation from a laser discharge tube to provide the laser discharge tube assembly.
